(19) United States
(12) Patent Application Publication
(10) Pub. No.: US 2014/0259569 A1
(43) Pub. Date: Sep. 18, 2014

(54) FIXTURE FOR MOUNTING VEHICLE-MOUNTED ARTICLE HOLDER IN AIR-CONDITIONER OUTLET

(71) Applicant: Beat-Sonic Co., Ltd., Nisshin-shi (JP)

(72) Inventor: Eiji MIYAJIMA, Nisshin-shi (JP)

(73) Assignee: Beat-Sonic Co., Ltd., Nisshin-shi (JP)

(21) Appl. No.: 14/179,005

(22) Filed: Feb. 12, 2014

(30) Foreign Application Priority Data
Mar. 14, 2013 (JP) 2013-051459

(51) Int. Cl. F16B 2/12

(52) U.S. Cl. CPC F16B 2/12
USPC 24/527

(57) ABSTRACT

A fixture for mounting a vehicle-mounted article on a louver of car air conditioner outlet includes an elongated body having first and second ratchet teeth, back and front sliding pieces including first and second pawl teeth resiliently engaging the first and second ratchet teeth, first and second releasing members configured to release the first and second pawl teeth and ratchet teeth from an engaged state, and first and second hooks capable of hooking louver front and back ends, respectively. The back sliding piece is slidable to the body proximal end side when the first ratchet teeth are engaged with the first pawl teeth. The front sliding piece is slidable to the body distal end side when the second ratchet teeth are engaged with the second pawl teeth.

### CROSS-REFERENCE TO RELATED APPLICATIONS

This application is based upon and claims the benefit of priority from the prior Japanese Patent Application No. 2013-051459 filed on Mar. 14, 2013, the entire contents of which are incorporated herein by reference.

### BACKGROUND

1. Technical Field

The present disclosure relates to a fixture for mounting a vehicle-mounted article holder, such as a cup holder or a smartphone holder, on a louver provided in a car air conditioner outlet.

2. Related Art

Japanese Patent Application Publication No. JP-A-2006-182270 discloses one type of a fixture for mounting a vehicle-mounted article holder on a louver provided in a car air conditioner outlet. The disclosed fixture includes a sliding piece and an elongated body. The body of the fixture has an upper surface having a plurality of ratchet teeth formed in a lengthwise direction. The body also has a proximal end provided with a mounting portion on which a vehicle-mounted article holder is mounted and a distal end provided with a hook.

The sliding piece includes a plurality of pawl teeth which is engaged with the ratchet teeth, a releasing member which releases the pawl teeth and the ratchet teeth from engagement, and a hook.

The sliding piece is assembled to the body so as to be slidable to the distal end side when the pawl teeth are engaged with the ratchet teeth and so as to be disallowed to slide to the proximal end side.

According to the above-described conventional fixture, the body is inserted into an air outlet of the air conditioner, and the distal end hook of the body is hooked on an inner or back end of the louver. The sliding piece is then slid to the distal end side of the body so that the hook of the sliding piece is hooked onto a front end of the louver, whereby the louver is held between the hooks of the body and the sliding piece. The mounting portion of the body protrudes from the outlet of the air conditioner into the interior of the passenger compartment when the body is mounted to the louver. As a result, a vehicle-mounted article holder can be mounted to the mounting portion.

The sliding piece is slid along the ratchet teeth of the body in use of the above-described conventional fixture, whereby the distance between the hooks of the body and the slide piece can be adjusted according to the width of the louver differing from one type of vehicle to another. Consequently, the vehicle-mounted article holder can be mounted to the car air conditioner outlet.

Meanwhile, a distance from an open end face of the air conditioner outlet to the louver differs from one type of vehicle to another. The louver is disposed in an inner part of the air conditioner outlet in one type of vehicle while the louver is disposed near the open end face of the air conditioner outlet in another type of vehicle.

In attaching the vehicle-mounted article holder to the air conditioner outlet using the above-described type of fixture, the holder is hung on the body mounting portion protruding out of the air conditioner outlet when the body of the fixture is longer than the distance from the open end face of the outlet to the louver. As a result, an oscillating motion during running of the vehicle shakes the holder thereby to render the holder unstable. This reduces the usability of the vehicle-mounted article held by the holder.

In order that the vehicle-mounted article holder may stably be mounted to the air conditioner outlet using the fixture, an end of the holder mounted to the mounting portion of the fixture is caused to abut against a lower end face of the outlet. As a result, the holder becomes difficult to shake and is accordingly rendered stable. However, the distance between the hook on the distal end of the body and the proximal end on which the mounting potion for mounting the holder needs to fit in well with the distance from a back end of the louver and the lower end face of the air conditioner outlet in order that the holder may be mounted to the air conditioner outlet so that the end of the holder is caused to abut against the lower end face of the outlet.

In the above-described conventional fixture, the distance between the hook and the proximal end of the fixture body is fixed and is variably unadjustable. Accordingly, when the holder is mounted to the air conditioner outlet using the fixture, the holder is hung on the body mounting portion protruding out of the air conditioner outlet depending upon the types of vehicles, with the result that the holder shakes and is accordingly unstable.

### SUMMARY

Therefore, an object of the disclosure is to provide a fixture for mounting a vehicle-mounted article, which can stably attach the holder to the air conditioner outlet.

The disclosure provides a fixture for mounting a vehicle-mounted article holder, such as a cup holder or a smartphone holder, on a louver provided in a car air conditioner outlet. The fixture includes an elongated body, a back sliding piece and a front sliding piece. The body has a top surface, an underside, a right surface and a left surface. The body has first ratchet teeth formed in one of the top surface and the underside or in one of the right and the left surfaces along an elongated direction. The body has second ratchet teeth formed in the other of the top surface and the underside or in the other of the right and the left surfaces. The body further has a proximal end provided with a mounting portion. The back sliding piece includes first pawl teeth resiliently engaging the first ratchet teeth, a first releasing member configured to release the first pawl teeth and the first ratchet teeth from an engaged state, and a first hook capable of hooking a back end of the louver. The front sliding piece includes second pawl teeth resiliently engaging the second ratchet teeth, a second releasing member configured to release the second pawl teeth and the second ratchet teeth from an engaged state, and a second hook capable of hooking a front end of the louver. The back sliding piece is assembled to the body so as to be slidable to the body proximal end side and so as to be non-slidable to a body distal end side when the first ratchet teeth are engaged with the first pawl teeth. The front sliding piece is assembled to the body so as to be slidable to the body distal end side and so as to be non-slidable to the body proximal end side when the second ratchet teeth are engaged with the second pawl teeth. The first hook is hooked on the back end of the louver and the second hook is hooked on the front end of the louver.

According to the above-described construction, the paired front and back sliding pieces are slidable along the body. Consequently, a distance between the hooks provided on respective sliding pieces can be adjusted according to a width of the louver.

Since distances from the proximal end of the body to both sliding pieces are adjustable, respectively, the sliding pieces are slid to the body proximal end side when the louver is disposed near the open end face of the air conditioner outlet. On the other hand, when the louver is disposed near the back side of the outlet, both sliding pieces are slid to the body distal end side. Consequently, a projection of the mounting portion from the open end face of the air conditioner outlet can be rendered constant irrespective of differences in vehicle types.

Accordingly, the vehicle-mounted article holder can stably be mounted to the air conditioner outlet irrespective of the differences in the vehicle types when the projection of the mounting portion is set so that an end of the holder abuts against a lower end face of the air conditioner outlet when the holder is mounted to the mounting portion.

The back sliding piece is assembled to the body so as to be non-slidable to the body distal end side when the first ratchet teeth are in engagement with the first pawl teeth, and the front sliding piece is assembled to the body so as to be non-slidable to the body proximal end side when the second ratchet teeth are in engagement with the second pawl teeth. Accordingly, the distance between the hooks of both sliding pieces holding the louver therebetween has no possibility of being increased by an oscillating motion during running of the vehicle. Consequently, the body can reliably be prevented from inadvertently dropping off from the louver.

In one embodiment, the fixture further includes a slide block having right and left sides and an underside from which the first or the second hook droops, a flexible portion formed on the right or the left side of the slide block so as to be capable of outwardly flexing the right or the left side of the slide block, the flexible portion having an inner surface formed with the first or second pawl teeth and an outer surface formed with a knob serving as the first or second releasing member. In the fixture, the first ratchet teeth are formed in one of the right and the left surfaces of the body and the second ratchet teeth are formed in the other of the right and the left surfaces. The first pawl teeth of the slide block serving as the back sliding piece are engaged with the first ratchet teeth. The second pawl teeth of the slide block serving as the front sliding piece are engaged with the second ratchet teeth. According to this construction, the slide block can be shared between the back and front sliding pieces, reducing the number of components and accordingly the costs.

In another embodiment, the body has a groove-shaped cutout perpendicular to the lengthwise direction, the body being breakable at the cutout thereby to be shortened. According to this construction, when the body is so long that the body abuts against an obstacle located in the back of the air conditioner outlet when inserted into the outlet, the body can be cut at the cutout thereby to be shortened. As a result, the body can be prevented from abutting against the obstacle.

### BRIEF DESCRIPTION OF THE DRAWINGS

In the accompanying drawings:

FIG. 1 is a perspective view of a fixture for mounting a vehicle-mounted article, which can stably attach the holder to the air conditioner outlet, in accordance with one embodiment;

FIG. 2 is a plan view of the fixture;

FIG. 3 is a diagrammatic view showing a mounting manner of the fixture;

FIG. 4 is also a diagrammatic view showing another mounting manner of the fixture;

FIG. 5 is further a diagrammatic view showing further another mounting manner of the fixture;

FIG. 6 is still further a diagrammatic view showing still further another mounting manner of the fixture; and

FIG. 7 is a perspective view of the fixture in accordance with a second embodiment.

### DETAILED DESCRIPTION

Embodiments will be described with reference to the accompanying drawings. FIGS. 1 and 2 show a fixture 10 for mounting a holder of a vehicle-mounted article on a louver provided in a car air conditioner outlet. The fixture 10 includes a body 11 which is a molded plastic product, a back slide block 12 and a front slide block 13. The body 11 is formed into the shape of a bar having a generally rectangular section. The body 11 has a left side formed with first ratchet teeth 11a along an elongated direction and a right side formed with second ratchet teeth 11b along the elongated direction. The first and second ratchet teeth 11a and 11b are directed oppositely. More specifically, the first ratchet teeth 11a are formed so as to have inclined faces at the side of a distal end 11c of the body 11, whereas the second ratchet teeth 11b are formed so as to have inclined faces at the side of a proximal end 11d of the body 11.

The distal end 11c of the body 11 is tapered and the proximal end 11d of the body 11 has a circular mounting portion 11e to which a holding member for mounting a vehicle-mounted article is detachably attachable. The holding member includes a cup holder or a smartphone holder. The mounting portion 11e is formed integrally with a shaft 11g convexed on a rectangular plate 11f. The mounting portion 11e has a larger diameter than the shaft 11g.

The back and front slide blocks 12 and 13 have the same shape and the same dimensions. The back slide block 12 includes right and left sides 12b and 12a and an underside 12c, and the front slide block 13 includes right and left sides 13b and 13a and an underside 13c. Each slide block is formed so as to have a generally C-shaped section. The side 12a is formed with two, upper and lower slits 12d and 12e, and the side 13a is formed with two, upper and lower slits 12d and 12e. The slits 12d and 12e each extend from one end of the side 12a to a middle part. Flexible portions 12f and 13f are formed by both slits 12d and 12e respectively. The sides 12a and 13a are outwardly flexible by the flexible portions 12f and 13f respectively. The flexible portions 12f and 13f have inner surfaces formed with pawl teeth 12g and 13g which elastically engage the first and second ratchet teeth 11a and 11b of the body 11, respectively. The flexible portions 12f and 13f have outer surfaces formed with releasing knobs 12h and 13h respectively. Hooks 12k and 13k droop from the undersides 12c and 13c respectively. The back slide block 12 is mounted to the body 11 so that the pawl teeth 12g engage the first ratchet teeth 11a. Furthermore, the front slide block 13 is mounted to the body 11 so that the pawl teeth 13g engage the second ratchet teeth 11b.

FIGS. 3 to 6 show a manner of using the fixture 10 structured as described above. A hook plate 20 is mounted to the mounting portion 11e as shown in FIG. 3. A vehicle-mounted article holder (not shown) is detachably attachable to the hook plate 20. The hook plate 20 includes a base plate 21 which has an upper part formed with an engagement groove the mounting portion 11e disengageably engages. The hook plate 20 is mounted to the body 11 of the fixture 10 by engaging the mounting portion 11e with the engagement groove. The base plate has a lower part provided with a support piece 22 which is mounted via a shaft 23 on the lower part so as to be swingable. The support piece 22 abuts against a lower end face 31 of an outlet of car air conditioner. The base plate 21 has a front face provided with a hook piece 24 which disengageably engages an engagement groove (not shown) of the vehicle-mounted article holder.

The air conditioner outlet 30 shown in FIG. 3 has three louvers 32, 33 and 34 provided near an open end face of the outlet 30. In order that the fixture 10 may be mounted in the outlet 30, the back slide block 12 located at the proximal end 11d side of the body 11 is fixed to a predetermined position of the body 11 according to a distance from the open end face of the outlet 30 to a back end of the louver 33. The slide blocks 12 and 13 can be slid both to the back side and to the front side when the releasing knobs 12h and 13h are gripped by fingers so that the flexible portions 12f and 13f are flexed outward, whereby the pawl teeth 12g and 13g are disengaged from the ratchet teeth 11a and 11b, respectively. The slide blocks 12 and 13 are fixed to the body 11 when the flexible portions 12f and 13f are returned to the former positions and the pawl teeth 12g and 13g are engaged with the ratchet teeth 11a and 11b, respectively.

The body 11 and both slide blocks 12 and 13 are inserted between the louvers 32 and 33, and the hook 12k of the back slide block 12 is hooked on the back end of the louver 33. The front slide block 13 is slid by fingers to the back side of the body 11, and the hook 13k of the front slide block 13 is engaged with the front end of the louver 33. As a result, the fixture 10 is mounted to the air conditioner outlet 30. The fixture 10 can stably be mounted in the air conditioner outlet 30 when the louver 33 to which the fixture 10 is to be mounted is selected so that the support plate 22 abuts against the lower end face 31 of the air conditioner outlet 30 when the fixture 10 is mounted to the louver.

In an air conditioner outlet 40 shown in FIG. 4, the louvers 42, 43 and 44 are provided inner relative to the air conditioner outlet 40 than relative to the air conditioner outlet 30. When the fixture 10 is mounted to the air conditioner outlet 40, the back slide block 12 is located at the distal end side of the body 11. The back slide block 12 is fixed to a predetermined position of the body 11 according to a distance from the open end face of the outlet 40 to the back end of the louver 43. The body 11 and both slide blocks 12 and 13 are inserted between the louvers 42 and 43, and the hook 12k of the back slide block 12 hooked on the back end of the louver 43. The front slide block 13 is slid by fingers to the back side of the body 11, whereby the hook 13k is engaged with the front end of the louver 43. As a result, the fixture 10 is mounted in the air conditioner outlet 40.

An air conditioner outlet 50 shown in FIG. 5 has a lower end face 51 protruding further forward than an upper end face. When the fixture 10 is mounted in this air conditioner outlet 50, the back slide block 12 is fixed to the body 11 while the fixture 10 is adjusted to a distance between the louvers 53, 54 and 55 and the lower end face 51 of the outlet 50.

An air conditioner outlet 60 shown in FIG. 6 also has a lower end face 61 protruding further forward than an upper end face 62. Furthermore, two 64 and 65 of three louvers 63, 64 and 65 are exposed outside the open end face. When the fixture 10 is mounted in the outlet 60, too, the back slide block 12 is fixed to the body 11 while the fixture 10 is adjusted to a distance between the louver 64 and the lower end face 61 of the outlet 60.

According to the fixture 10 of the first embodiment, the paired front and back slide blocks 13 and 12 are slidable along the body 11. Consequently, the distance between the hooks 13k and 12k provided on respective slide blocks 13 and 12 can be adjusted according to the width of the louver 33, 43, 54 or 64.

Since distances from the proximal end 11d of the body 11 to both slide blocks 12 and 13 are adjustable, respectively, the slide blocks 12 and 13 are slid to the body proximal end 11d side when the louver 32 is disposed near the open end face of the air conditioner outlet 30, as shown in FIG. 3. On the other hand, when the louver 43 is disposed near the back side of the outlet 40, both slide blocks 12 and 13 are slid to the body distal end 11c side, as shown in FIG. 4. Consequently, a projection of the mounting portion 11e from the open end face of the air conditioner outlet 30 or 40 can be rendered constant irrespective of differences in vehicle types.

Accordingly, the vehicle-mounted article holder can stably be mounted to the air conditioner outlet 30 or 40 irrespective of the differences in the vehicle types when the projection of the mounting portion 11e is set so that the support plate 22 abuts against the lower end face 31 or 41 of the air conditioner outlet 30 or 40 when the vehicle-mounted holder is mounted to the mounting portion 11e.

The back slide block 12 is assembled to the body 11 so as to be non-slidable to the body distal end 11c side when the first ratchet teeth 11a are in engagement with the pawl teeth 12g, and the front slide block 13 is assembled to the body 11 so as to be non-slidable to the body proximal end 11d side when the second ratchet teeth 11b are in engagement with the pawl teeth 13g. Accordingly, the distance between the hooks 12k and 13k of both slide blocks 12 and 13 holding the louver 33, 43, 54 or 64 therebetween has no possibility of being increased by an oscillating motion during running of the vehicle. Consequently, the body 11 can reliably be prevented from inadvertently dropping off from the louver 33, 43, 54 or 64.

Since the back and front slide blocks 12 and 13 have the same shape and the same dimensions, a single type of slide block can be shared between the back and front slide blocks 12 and 13, with the result that the number of components and accordingly the costs can be reduced.

FIG. 7 shows a fixture 10A for mounting a holder of a vehicle-mounted article on a louver provided in a car air conditioner outlet. The body 11 of the fixture 10A has a groove-shaped cutout 11h perpendicular to the lengthwise direction. The body 11 is breakable at the cutout 11h thereby to be shortened. The fixture 10A of the second embodiment is identical with the fixture 10 in the other respects. Identical or similar parts in the second embodiment are labeled by the same reference symbols as those in the first embodiment, and the description of these parts will be eliminated.

According to the above-described construction, when the body 11 is so long that the body 11 abuts against an obstacle located in the back of the air conditioner outlet 30, 40, 50 or 60 when inserted into the outlet 30, 40, 50 or 60, the body 11 can be cut at the cutout 11h thereby to be shortened. As a result, the body 11 can be prevented from abutting against the obstacle.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A fixture for mounting a vehicle-mounted article, such as a cup holder or a smartphone holder, on a louver provided in a car air conditioner outlet, the fixture comprising:
an elongated body having a top surface, an underside, a right surface and a left surface, the body having first ratchet teeth formed in one of the top surface and the underside or in one of the right and the left surfaces along an elongated direction, the body having second ratchet teeth formed in the other of the top surface and the underside or in the other of the right and the left surfaces, the body further having a proximal end provided with a mounting portion;
a back sliding piece including first pawl teeth resiliently engaging the first ratchet teeth, a first releasing member configured to release the first pawl teeth and the first ratchet teeth from an engaged state, and a first hook capable of hooking a back end of the louver; and
a front sliding piece including second pawl teeth resiliently engaging the second ratchet teeth, a second releasing member configured to release the second pawl teeth and the second ratchet teeth from an engaged state, and a second hook capable of hooking a front end of the louver, wherein:
the back sliding piece is assembled to the body so as to be slidable to the body proximal end side and so as to be non-slidable to a body distal end side when the first ratchet teeth are engaged with the first pawl teeth;
the front sliding piece is assembled to the body so as to be slidable to the body distal end side and so as to be non-slidable to the body proximal end side when the second ratchet teeth are engaged with the second pawl teeth; and
the first hook is hooked on the back end of the louver and the second hook is hooked on the front end of the louver.

2. The fixture according to claim 1, further comprising:
a slide block having right and left sides and an underside from which the first or the second hook droops;
a flexible portion formed on the right or the left side of the slide block so as to be capable of outwardly flexing the right or the left side of the slide block, the flexible portion having an inner surface formed with the first or second pawl teeth and an outer surface formed with a knob serving as the first or second releasing member, wherein:
the first ratchet teeth are formed in one of the right and the left surfaces of the body and the second ratchet teeth are formed in the other of the right and the left surfaces;
the first pawl teeth of the slide block serving as the back sliding piece are engaged with the first ratchet teeth; and
the second pawl teeth of the slide block serving as the front sliding piece are engaged with the second ratchet teeth.

3. The fixture according to claim 1, wherein the body has a groove-shaped cutout perpendicular to the lengthwise direction, the body being breakable at the cutout thereby to be shortened.
